(19) United States
(12) Patent Application Publication
(10) Pub. No.: US 2026/0256061 A1
(43) Pub. Date: Sep. 3, 2026

(54) GROWING GUTTER SYSTEM FOR SUPPORTING HORTICULTURE CROPS PLACED THEREON

(71) Applicant: Metazet Formflex Activa B.V., Wateringen (NL)

(72) Inventors: Lucas Gerardus Van Adrichem, Wateringen (NL); Ronald Bernardus Adriaan Boeters, Wateringen (NL); Dirk Den Butter, Wateringen (NL); Rudolf Petrus Jacobus Grootscholten, Wateringen (NL)

(21) Appl. No.: 19/163,878

(22) PCT Filed: Mar. 15, 2024
(86) PCT No.: PCT/NL2024/050131

§ 371 Date: Sep. 10, 2025

(30) Foreign Application Priority Data
Mar. 16, 2023 (NL) 2034360

(51) Int. Cl. A01G 9/04; A01G 9/14

(52) U.S. Cl. CPC A01G 9/047; A01G 9/14

(57) ABSTRACT

A growing gutter system for supporting horticulture crops placed thereon includes: a longitudinal supporting member for supporting the weight of said horticulture crops; an upper longitudinal gutter member made from a formable sheet material including an upper surface for placement of horticulture crops thereon, where the upper longitudinal gutter member is made separately from the longitudinal supporting member; a drainage channel running parallel along the length of the upper longitudinal gutter member and where the upper longitudinal gutter member is arranged for draining liquid from the upper surface to the drainage channel; where the upper longitudinal gutter member is pre-formed to obtain its shape and is arranged on the longitudinal supporting member, such that the pre-formed upper longitudinal gutter member at least partially encloses the longitudinal supporting member, such that any liquid draining from the horticulture crops runs over the upper surface towards the drainage channel.

### CROSS-REFERENCE TO RELATED APPLICATIONS

This application is the National Stage of International Application No. PCT/NL2024/050131, filed Mar. 15, 2024, which claims the benefit of Netherlands Application No. 2034360, filed Mar. 16, 2023, the contents of which is incorporated by reference herein.

### FIELD OF THE INVENTION

The present invention relates to a growing gutter system for supporting horticulture crops placed thereon and to a method of manufacturing said growing gutter.

### BACKGROUND OF THE INVENTION

In many horticulture greenhouses the horticulture crops are often arranged in consecutive rows of plants, wherein these crops, i.e. plants, are supported on growing gutters. These plants are, typically, rooted in a plant substrate, such as (rockwool) substrate blocks, which plant substrates are placed on the growing gutter. Excess irrigation water, and fertilizer, is allowed to drain from the plant substrate into a drainage channel of the growing gutter.

These growing gutters are typically suspended from the floor of the horticulture greenhouse, by either arranging these on a series of spaced apart legs that are supported directly onto the floor of the horticulture greenhouse, or are suspended by tension members, such as cables or rods, that extend downwards from the roof structure of the horticulture greenhouse. In order to be able to support the weight of the crops placed thereon, these growing gutters are typically formed from coated steel strip that is rolled into a three-dimensional, typically U-shaped, gutter. Advantages of these growing, i.e. cultivation, gutter systems are numerous, such as making cultivation possible on infertile land, saving water by reusing drain water, reducing the use of fertilizers by reusing drain water and improved working conditions by working at the correct height.

Nonetheless, these existing gutter systems also have a number of disadvantages. Firstly, the drainage channels are typically constantly wetted by still-standing drainage water, which can be caused by local blockages in these channels, a non-constant slope at which the gutter is arranged. This can cause, or at least stimulate, the growth of organic material, such as algae, in the drainage channels, cause the roots of the crops positioned on top of the gutter system to root themselves in the drainage channels, thereby causing further blockages. These such pools of the still-standing drainage water, and the organic material growing therein, can further act as reservoirs of plant diseases. Additionally, this can cause, even in case of small damages to the applied coating, typically a lacquer, the steel strip to rust and corrode, which can again cause further blockages and also limits the lifetime of the gutter system.

At the end of season, the crops are typically removed and the greenhouse and it interior is cleaned. The gutter systems are typically cleaned using a cleaning agents, which can also damage the coating layer, causing the gutter to corrode, further accelerating the above described process.

### SUMMARY OF THE INVENTION

The current invention seeks to provide an improved growing gutter system, and process of manufacturing said growing gutter system, wherein at least some of the above presented problems are at least alleviated an preferably overcome.

In a first aspect, the invention relates to a growing gutter system for supporting horticulture crops placed thereon, comprising:
a longitudinal supporting member, in particular a longitudinal beam member, for supporting the weight of said horticulture crops;
an upper longitudinal gutter member made from a formable sheet material, in particular a plastic sheet material, comprising an upper surface for placement of horticulture crops thereon, wherein said upper longitudinal gutter member is made separately from said longitudinal supporting member;
a drainage channel running parallel along the length of the upper longitudinal gutter member and wherein the upper longitudinal gutter member is arranged for draining liquid from the upper surface to the drainage channel;
wherein the upper longitudinal gutter member is pre-formed to obtain its shape and is arranged on the longitudinal supporting member, such that the pre-formed upper longitudinal gutter member at least partially encloses said longitudinal supporting member, such that any liquid draining from said horticulture crops runs over the upper surface towards the drainage channel.

As the growing gutter system according to the invention effectively splits supporting function, i.e. the strength and stiffness that such a growing gutter should have in order to support the weight of the plants placed thereon without collapsing, and the function of collecting and guiding the drainage water that drains from the plants placed thereon, the system allows to separate the drainage water flows from the material (typically steel, although other materials providing sufficient stiffness and strength can also be envisioned) of the longitudinal supporting member, thereby significantly reducing the problem of corrosion and thereby increasing the lifetime of the longitudinal supporting member. This, for instance, allows to use simple unlacquered steel, such as galvanized steel strip for forming the longitudinal supporting members. It is further noted that the longitudinal supporting member and upper longitudinal gutter member are, preferably, arranged co-axial around a central longitudinal axis of the growing gutter system.

As the upper longitudinal member is made from a pre-formed material, such as a plastic sheet material that is able to hold its form, as opposed to a material that cannot be pre-formed, such a plastic foil material that cannot hold its form on its own, it can be arranged tightly on/around the longitudinal supporting member, such that wrinkles in the material are prevented, thereby enabling a continuous flow path for the drainage material, such that pools of stand-still drainage water on the supporting surface are at least reduced, preferably prevented.

Additionally, upon cleaning the growing gutter system according to the invention, one can remove the upper longitudinal gutter member from the longitudinal supporting member to either clean it, or replace it with a new, or cleaned and/or refurbished, upper longitudinal gutter member. In order to reduce any growth of algae, and/or similar organisms, the interior surfaces of the drainage channel preferably have a dark color that reduces the reflection of light, such as black, dark green, blue, grey and/or combination of these. The dark colored surface may be obtained by, for instance, printing methods, or by (locally) laminating, for instance by melting, a secondary layer of a dark material on the interior surface of the drainage channel.

In a preferred embodiment, said upper longitudinal gutter member comprises at least an upper wall that comprises said upper surface and a side wall that extends from the upper wall, with respect to the upper surface thereof, in at least a downward direction and, preferably, wherein an outer surface of said side wall is arranged for guiding the draining liquid from the upper surface to the drainage channel. It is further noted that the upper wall, in particular said upper surface, and/or side wall, in particular said outer surface of the side wall, are preferably closed walls and/or surfaces having, at least at locations where the upper longitudinal gutter member abuts, or is arranged around, the longitudinal supporting member, no through holes therethrough, such that, when in use, drainage water draining from the upper surface to the drainage channel cannot come in direct contact with the longitudinal supporting member. The above described functional split is thereby enabled.

Preferably, at least a part of an inner circumference of said upper longitudinal gutter member is shaped to closely fit over at least a part of the outer circumference of the longitudinal supporting member. Hereby, the upper longitudinal gutter member is effectively supported by the longitudinal supporting member, while still preventing the drainage water from coming into contact with the longitudinal supporting member.

In a preferred embodiment, the drainage channel is formed monolithically with said upper longitudinal gutter member, such that said upper longitudinal gutter member and drainage channel are formed from the same piece of pre-formed material. This allows for an efficient flow path from the upper surface to the drainage channel, while the pre-formed material prevents wrinkles to occur in the drainage channel, such that local pools of still-standing drainage water is prevented. It also enables to replace and/or clean the “wetted parts”, i.e. the parts of the gutter system that come into contact with the drainage water, in a single step.

Preferably, said drainage channel is arranged at, or below, a lower end of the side wall of the longitudinal gutter member, and/or wherein the cross-section of the upper longitudinal gutter member is at least L-shaped, and preferably, wherein the leg of the L-shape is arranged with an at least J-shaped end section for forming the drainage channel. Such a shape, that can be easily formed by folding a pre-formable material, such as plastic sheet material, allows for a simple flow path for the drainage water from the upper surface to the drainage channel.

It is preferred that the sheet material of the upper longitudinal gutter member is a foldable sheet material, in particular a creased and/or scored sheet material, such that the upper longitudinal gutter member is, preferably, pre-formed by folding along pre-applied creasing/scoring lines, and/or wherein said sheet material is a plastic sheet material, preferably made from PE (Polyethylene) or PP (Polypropylene). A foldable sheet material is efficiently transportable to site, such that it enables forming the upper longitudinal gutter members on site (i.e. in situ), e.g. in the horticulture greenhouse where said growing gutter system is to be installed. This allows to create a full length upper longitudinal gutter members, that can extend from more than 30 meters to 160 meters or even more, from a single sheet of material, thereby avoiding any coupling sections (e.g. welded, glued, or the like). This is, for instance, possible by using a roll forming process, wherein the formable (plastic) sheet material is provided on a roll, such the sheet material that is rolled from said roll is progressively formed between a form rollers to form a final profile of the upper longitudinal gutter member.

A creased and/or scored sheet material allows to pre-form bending lines in the material, such that the upper longitudinal gutter member is easily brought into shape and installed on site. Plastic sheet material, such as PE or PP, is not susceptible to corrosion and can be cleaned more easily, thereby enabling a cleaner horticulture process and enabling a longer lifetime of the growing gutter system. It is noted that the material may be creased and/or scored in situ, i.e. just before pre-forming the material for forming the upper longitudinal gutter member, as also is described in more detail below.

Preferably, the formable sheet material of the upper longitudinal gutter member has a thickness in the range of 0.1-3 mm, preferably in the range of 0.15-1.5 mm, more preferably in the range of 0.2-1 mm, although also thicknesses in the range of 0.4-0.8 mm are preferable. Sheet material having a thickness in these ranges allows to form the upper longitudinal gutter member is such a way that it is able to retain its form, while not requiring heavy and expensive tooling for forming said upper longitudinal gutter member.

In a preferred embodiment, the growing gutter system comprises a second drainage channel running parallel along the length of the upper longitudinal gutter member and wherein the upper longitudinal gutter member is also arranged for draining liquid from the upper surface to the second drainage channel, such that, preferably a cross-section of the growing gutter system is substantially mirror symmetric with respect to a mirror line running substantially perpendicular to the upper surface and through a central longitudinal axis of the growing gutter system. By providing a second drainage channel running parallel along the length of the upper longitudinal gutter member, the upper longitudinal gutter member can be arranged on/around existing growing gutters to retrofit these. Thereby, the above described advantages can be obtained in a simple manner by upgrading the existing growing gutters.

It is preferred that, when determined at a nominal temperature of 20° C., said upper longitudinal gutter member is arranged on the longitudinal supporting member with a pretension. As the longitudinal supporting member will typically be made from a material, such as a metal, such as steel, that is different from the material of the upper longitudinal gutter member, said members will have a different thermal coefficient of expansion. By, when determined at a nominal temperature of 20° C., making the upper longitudinal gutter member slightly shorter than the longitudinal supporting member, said upper longitudinal gutter member will be pretensioned over the typical range of temperatures that the growing gutter system is exposed to in a horticulture greenhouse. This pretension thereby prevents compression to occur in the upper longitudinal gutter member, whereby wrinkles and/or localized buckling of the upper longitudinal gutter member is prevented, as these can cause blockages in the flow of draining liquid (and the associated problems that come with these blockages).

It is then preferred that said longitudinal supporting member comprises, at the respective end sections, upper longitudinal gutter member attachment sections arranged for a pre-tensioned fixation of said upper longitudinal gutter member to the longitudinal supporting member. This enables to mount the upper longitudinal gutter member with the above-described pre-tension.

Preferably, the longitudinal supporting member is made from metal sheet material, and/or wherein the longitudinal supporting member is a thin-walled longitudinal beam member having a cross-section that comprises at least a U-shaped or semi-circular section. By forming said longitudinal supporting members from metal sheet material, allows to create a full length longitudinal supporting members in situ (e.g. in the horticulture greenhouse where the growing gutter system is to be installed), that can extend from more than 30 meters to 100 meters or even more, from a single sheet of material, thereby avoiding any coupling sections (e.g. welded, glued, or the like), that could lead to weaker spots and/or increase the complexity of forming said longitudinal supporting member. This is, for instance, possible by using a roll forming process, wherein metal sheet material is provided on a roll, such that a strip of said sheet metal that is rolled from said roll is progressively formed between a form rollers to form a final profile.

It is further preferred that said thin-walled longitudinal beam member comprises a substantially closed cross-section or an open cross-section having a curl or hem at the longitudinal edges. This enable to obtain a longitudinal supporting member that has a higher bending stiffness, such that it is able to support more weight from the crops placed thereon. The longitudinal edges of the sheet material may be joined together, for instance by welding, gluing, or forming a force-or form-closed connection between the respective longitudinal end sections, or said longitudinal edges may not be joined together.

In a preferred embodiment, the system comprises a plurality of joining bracket members, wherein said bracket members are arranged for holding and adjoining said longitudinal supporting member, said upper longitudinal gutter member and, preferably, said drainage channel(s). The brackets provide for a way of (removably) coupling said members, without requiring the use of specialized equipment, in a manner that said members may be decoupled again for cleaning and/or refurbishment purposes.

It is then preferred said joining bracket members are arranged around the outer circumference of the longitudinal supporting member, such that said bracket members are in between the longitudinal supporting member and the upper longitudinal gutter member and preferably, wherein said joining bracket members comprise a holding end section for holding the upper longitudinal gutter member in the pre-formed shape, wherein the holding end section preferably comprise one or two J-shaped end sections for holding therein the drainage channel(s) in their pre-formed shape. The brackets themselves, which are preferably formed from a metal, such a galvanized steel, are thereby also shielded from direct contact with the draining liquid. Additionally, the aid in supporting to retain the shape of the upper longitudinal gutter member and the drainage channel, such that thinner formable sheet material may be used, which reduced the overall material usage of said system. Alternatively, said joining bracket members are arranged around at least a part of the outer circumference of the upper longitudinal gutter member, in particular around outer longitudinal edges of the upper longitudinal gutter member, such that said bracket members are arranged around the longitudinal supporting member and the upper longitudinal gutter member; and/or wherein, preferably, the longitudinal supporting member is provided with (a) drainage channel supporting base(s) for holding therein the drainage channel(s) in their pre-formed shape. Hereby, the brackets themselves, which are preferably formed from a metal, such a galvanized steel, bar or wire, are easily arranged upon installing the gutter system, as they are arranged externally of the upper gutter and supporting members.

It is preferred that said system further comprises a suspension system for suspending said grower gutter system from a suspended structure and/or roof structure of a horticulture green house at a predefined elevation height, said suspension system, preferably, comprising a plurality of longitudinal tension members, such as cables, that are arranged to extend downwardly from the suspended structure and/or roof structure of a horticulture green house and/or a plurality of suspension brackets that coupled to the longitudinal supporting member and are arranged for connecting to a plurality of longitudinal tension members extending downwardly from the suspended structure and/or roof structure of a horticulture green house. This allows to support the gutter system at a preferred working height. The use of separate suspension brackets allows to vary the distance between said brackets in dependence of the specific roof construction, in particular in dependence of a distance between beam and/or truss-structures of said roof construction, such that a modular system is obtained that can easily be installing in different types of greenhouses.

In a second aspect, the invention relates to a method of manufacturing a growing gutter system, in particular a growing gutter system according to any of the preceding claims, comprising the steps of:
providing a longitudinal supporting member for supporting the weight of horticulture crops;
providing an upper longitudinal gutter member made from a formable sheet material comprising an upper surface for placement of horticulture crops thereon, wherein said upper longitudinal gutter member is made separately from said longitudinal supporting member;
providing a drainage channel;
arranging said upper longitudinal gutter member on the longitudinal supporting member, such that the pre-formed upper longitudinal gutter member at least partially encloses said longitudinal supporting member;
arranging said drainage channel such that any liquid draining from said horticulture crops runs over the upper surface towards the drainage channel.

This allows to obtain a growing gutter system according to any of the above described embodiments and the related advantages.

Preferably, the step of providing the upper longitudinal gutter member comprises:
providing a longitudinal sheet of a formable sheet material, preferably having pre-arranged scoring and/or ceasing lines;
forming said upper longitudinal gutter member by bending, preferably along longitudinal creasing and/or scoring lines, said longitudinal sheet of formable sheet material to obtain at least an intermediate shaped gutter member having cross-sectional shape that is in between the undeformed shape of said longitudinal sheet and a final cross-sectional shape of said upper longitudinal gutter member;
and wherein step of arranging said upper longitudinal gutter member on the longitudinal supporting member comprises:
obtaining the final cross-sectional shape of the upper longitudinal gutter member and arranging it on the longitudinal supporting member.

Such a method allows to form the upper longitudinal gutter member in situ (e.g. in the horticulture greenhouse), such that the full length of the upper longitudinal gutter member may be formed integrally (i.e. monolithically). Any risk of leakages, through the interface of subsequent parts of a longitudinal gutter member, can thereby be prevented. This enables to minimize the risk of direct contact between the drainage liquid (and/or cleaning liquid for cleaning the upper longitudinal gutter member and/or drainage channel) and the longitudinal supporting member.

Alternatively, or additionally, the formable sheet material may be formed by (localized) heating of the formable sheet material, for instance along the longitudinal creasing and/or scoring lines. The material can thereby easily be formed in situ (e.g. in the horticulture greenhouse) using, for instance, a series of form rollers that are arranged for forming the upper longitudinal gutter member from the formable sheet material.

It is then further preferred that the step providing the upper longitudinal gutter member comprises:
providing the longitudinal sheet of a formable sheet material on a roll;
rolling off the longitudinal sheet of formable material from the roll, while simultaneously bending the rolled off material to obtain the cross-sectional shape of at least intermediate shaped gutter member. Providing the formable sheet material on a roll allows to compactly store and handle large lengths of sheet material, such that relatively upper longitudinal gutter member can be formed from a single piece of material, as has been described above. It is noted that any of these steps may be performed in situ, e.g. in the greenhouse wherein the gutters system is to be installed, or may be performed at a (more) remote production, after which the semi-finished products are shipped to site (e.g. the greenhouse).

Preferably, the step of providing a longitudinal supporting member comprises the steps of:
providing a longitudinal sheet of a secondary formable sheet material, preferably a metal sheet material, preferably on a roll of said secondary formable sheet material;
forming said longitudinal supporting member to have a predefined cross-section, with respect to a longitudinal axis of said longitudinal supporting member, by bending and plastically deforming said secondary formable sheet material; preferably by rolling off said material from the roll while simultaneously bending and plastically deforming the rolled off secondary material to obtain the longitudinal supporting member having the predefined cross-section.

This allows to form the longitudinal supporting member from a single piece of material in situ (e.g. in the horticulture greenhouse) using, for instance, a series of form rollers that are arranged for forming the upper longitudinal gutter member from the formable sheet material. One thereby avoids to (mechanically) assembly the longitudinal supporting member from a series of parts, thereby reducing the amount of labor required and furthermore reducing any possible weak spots that can occur in the mechanical interfaces between the respective parts.

Preferably, the steps of forming the cross-sectional shape of the upper longitudinal gutter member and the longitudinal supporting member are performed simultaneously and in parallel to each other and wherein the cross-sectional shape of the upper longitudinal gutter member is arranged on the cross-sectional shape of the longitudinal supporting member after forming the respective cross-sectional shapes. The entire growing gutter system can thereby be easily formed and assembled in-situ, which reduces labor that would otherwise be needed for assembling the different components of the growing gutter assembly. Furthermore, the longitudinal supporting member can furthermore aid in retaining the shape of the upper longitudinal gutter member, such that thinner formable (e.g. plastic) sheeting may be used for the upper longitudinal gutter member.

In a preferred embodiment, the drainage channel is monolithically formed with the upper longitudinal gutter member, preferably through bending the longitudinal sheet of a formable sheet material. This allows for obtaining a reliable, and preferably leak-free, flow-path between the upper longitudinal gutter member and the drainage channel, such that direct contact between drainage liquid and the longitudinal supporting member is prevented as much as possible. It further reduces the need for forming a separate drainage channel and allows to form the full length of the drainage channel from a single piece of material.

Preferably, the method is executed in the horticulture greenhouse wherein the growing gutter system is to be suspended, as was described above.

### BRIEF DESCRIPTION OF THE DRAWINGS

The present invention is further illustrated by the following figures, which show preferred embodiments of the invention and are not intended to limit the scope of the invention in any way, wherein:

FIG. 1 schematically shows a three-dimensional perspective of a growing gutter system according to a first embodiment of the invention having crops placed thereon.

FIG. 2 schematically shows a frontal view of the growing gutter system of FIG. 1 along a longitudinal axis thereof.

FIG. 3 schematically shows, in a more detailed view, a bracket coupling the various parts of the growing gutter system of FIG. 1.

FIG. 4 schematically shows, in an frontal exploded view, the growing gutter system of FIG. 1 along a longitudinal axis thereof.

FIG. 5 schematically shows, in a shows three-dimensional perspective exploded view, the growing gutter system of FIG. 1.

FIG. 6 schematically shows a three-dimensional perspective of a growing gutter system according to a second embodiment of the invention having crops placed thereon.

FIG. 7 schematically shows the growing gutter system of FIG. 6 without crops placed thereon.

FIG. 8 schematically shows, in a shows three-dimensional perspective exploded view, the growing gutter system of FIG. 6.

### DETAILED DESCRIPTION OF THE INVENTION

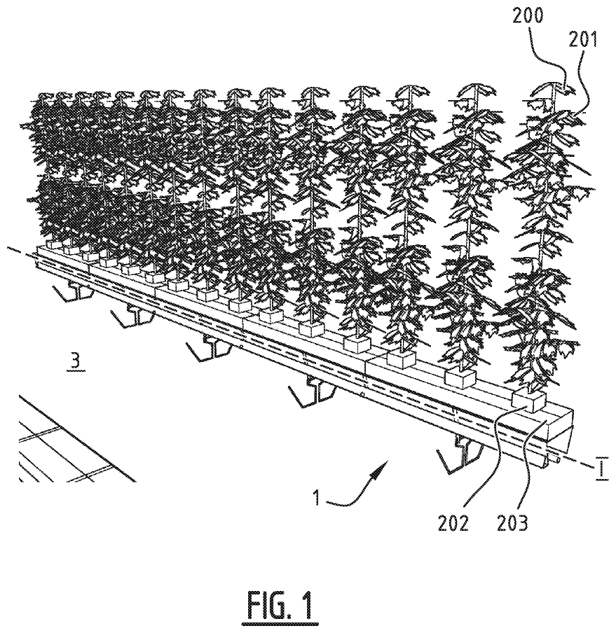

FIG. 1 shows a growing gutter system 1 according to an embodiment of the invention having crops 200 placed thereon, wherein the growing gutter 1 is located in, preferably, a greenhouse environment 3. The growing gutter system 1 extends along the longitudinal axis I. The crops 200, comprising plants 201, are shown to be rooted in substrate blocks 202, whereby a plurality of substrate blocks 202 are positioned on substrate slabs 203 to facilitate further growth of the roots of the plants 201. Commonly used substrate is for instance rock wool. The crops 200, in particular the substrate slabs 203, are positioned on an upper surface of the growing gutter system 1.

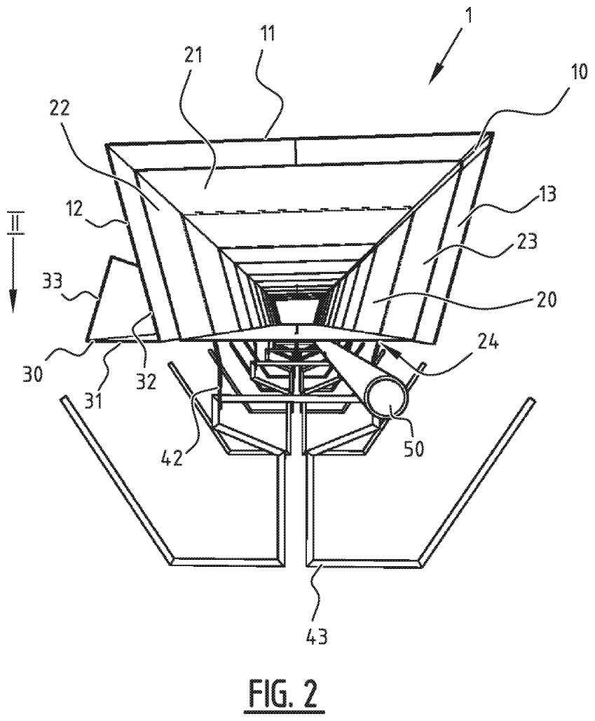

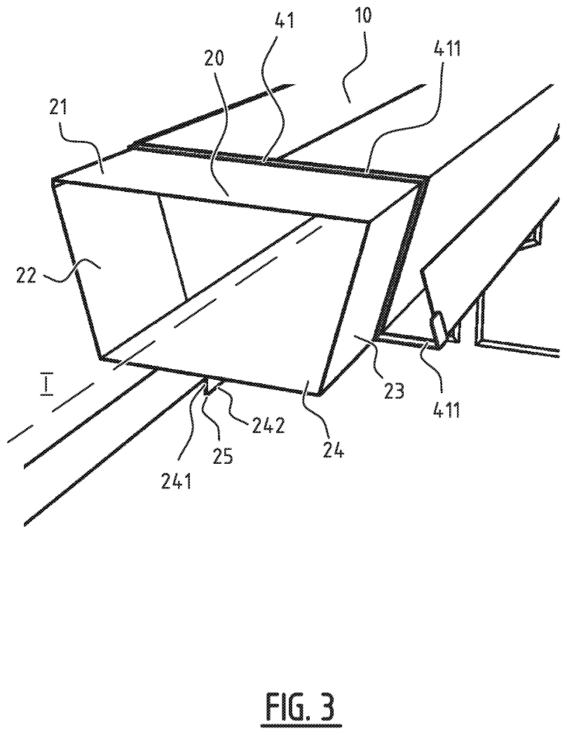

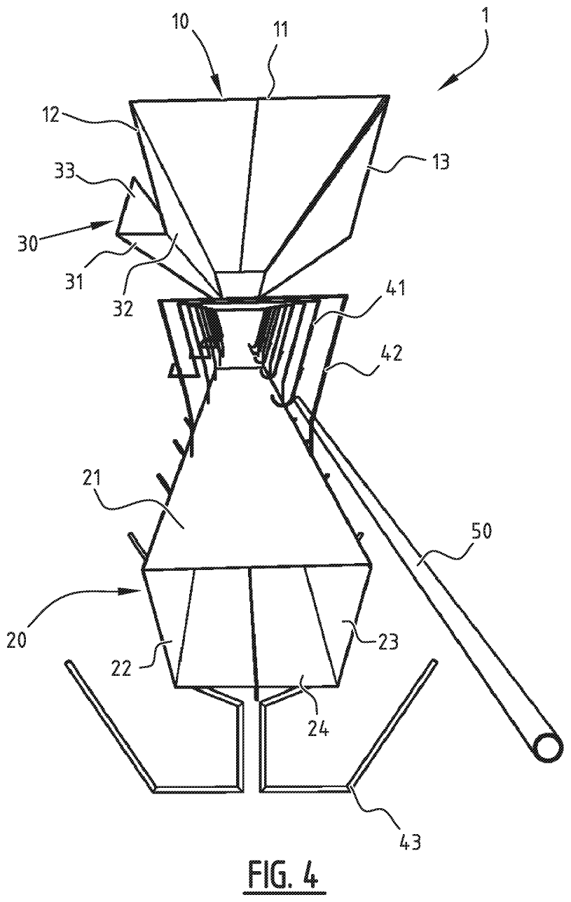

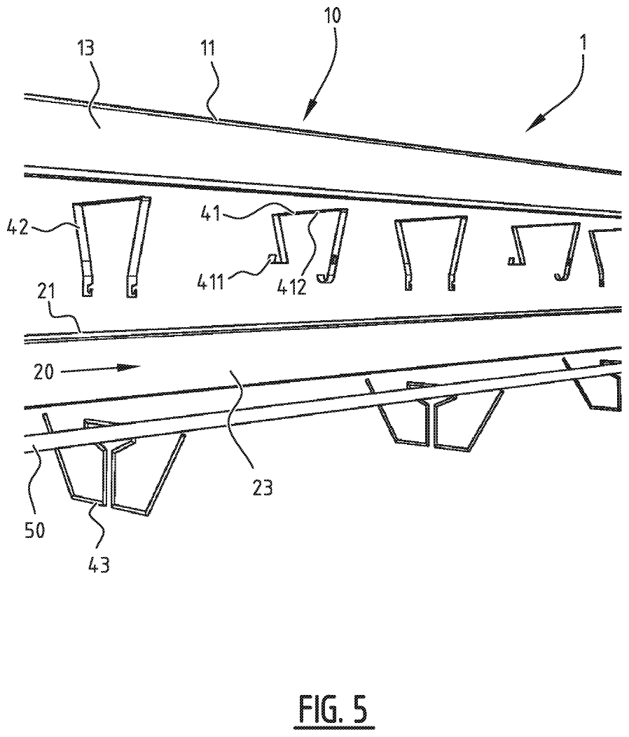

The growing gutter system 1, as is best seen in FIGS. 2-5 , comprise a longitudinal supporting member 20, that effectively acts as a longitudinal beam member for providing structural support, an upper longitudinal gutter member 10 that is arranged, substantially exactly, around the longitudinal supporting member 20, thereby effectively acting as an outer skin that covers, as least an upper part of the longitudinal supporting member 20, and a drainage channel 30 that is arranged parallel with the longitudinal supporting member 20 and the upper longitudinal gutter member 10. The a longitudinal supporting member 20 and upper longitudinal gutter member 10 are arranged co-axial around the longitudinal axis I.

Hanger hooks 43 may be arranged underneath the longitudinal supporting member 20 by suspending these from secondary brackets 42 that are connected to the longitudinal supporting member 20 and whose ends extend in a downward direction II with respect to the longitudinal supporting member 20 and the upper longitudinal gutter member 10. An irrigation water distribution tube 50 may be arranged with the growing gutter system 1, in particular in the hanger hooks 43, more in particular between the hanger hooks 43 and the longitudinal supporting member 20. The plants 201 may for instance be irrigated by used of such an irrigation water distribution (flexible) tube 50, whereby secondary irrigation water distribution hoses (not shown) having a smaller inner diameter than the irrigation water distribution tube 50 are used for providing irrigation water to the substrate blocks 202 and/or slabs 203. Hanger hooks 43 further enable to accommodate further tubular members (not shown) to run below and parallel to the growing gutter system 1, such as flexible perforated foil type tubes used for providing additional CO₂ to the plants 201 for supporting their development.

In use, irrigation water (and/or fertilizer) is supplied to the substrate blocks 202 and/or slabs 203 to feed the plants 201 rooted therein. Any excess irrigation water is allowed to drain from the substrate blocks 202 and/or slabs 203 as drainage water onto the growing gutter system 1. The growing gutter system 1 is arranged such that this drainage water runs over the upper surface 11 of the upper longitudinal gutter member 10 towards the drainage channel 30, wherein this drainage water is collected and drained towards a drainage water collecting and disposal system that can be arranged downstream of the drainage channel 30. As the drainage water runs only over the outer surface of the upper longitudinal gutter member 10, i.e. over the upper surface 11 and side surface 12 that preferably extends into the drainage channel 30, which are a closed surfaces (i.e. having no holes or openings therethrough), direct contact between the drainage water and the longitudinal supporting member 20 is prevented, as was explained above. Even though the current embodiment shows only a single drainage channel 30 that is arranged at one longitudinal side of the upper longitudinal gutter member 10, at a lower end thereof and parallel thereto, a second, preferably similar, drainage channel (not shown) can be provided at the opposing longitudinal side of the upper longitudinal member 10.

The drainage channel 30 is seen to have a substantially U-shaped cross-section having a bottom 31, and side walls 32, 33. It is noted that other cross-sections, such as a V-shape, semi-circular, or in general channel-shaped and/or a general concave surface, can also be envisioned. In the current embodiment, the drainage channel 30 is formed integrally with the upper longitudinal member 10, such that the side surface 12 seamlessly extends, as an inner surface of side wall 32, into the drainage channel 30. The cross-section of the side surface 12 and drainage channel 30 can thereby be considered a J-shape that is arranged at one of the legs (i.e. the side wall comprising side surface 12) of the substantially (inverted) U-shaped cross section of the upper longitudinal gutter member 10. The second drainage channel, as discussed above, can be formed in similar fashion to the other of the legs (i.e. the opposite side wall comprising second side surface 13) of the substantially (inverted) U-shaped cross section of the upper longitudinal gutter member 10.

The upper longitudinal gutter member 10 of the current embodiment is made from a formable plastic sheet material, in particular PE or PP, having a thickness of approximately 0.4-0.8 mm, although a thickness in the range of 0.10 mm-3 mm, as also described above, is also envisioned. In these ranges, the plastic sheeting will be able to, at least some extend, retain a preformed shape, while at the same time being formable enough to not require heavy duty forming equipment. The upper longitudinal gutter member 10 may be formed in situ as described above.

The longitudinal supporting member 20 comprises, in the current embodiment, a full (i.e. closed) circumferential cross-section, having a top wall 21, bottom wall 24, first side wall 22 and second side wall 23. The longitudinal supporting member 20 may be formed, using form rollers as described above, from metal, in particular long strips (e.g. more than 30 m or even more than 100 m) of galvanized steel sheet material. The outer longitudinal edges 241, 242 of the material thereby abut in the formed stated of the longitudinal supporting member 20, which in this particular embodiment form an outwardly extending lip 25 wherein said edges coincide with each other. The edges 241, 242 of the lip may be sealed and/or connected by various methods, such as gluing, welding and/or by form connecting, such as creasing, although the edges need not be connected.

Primary brackets 41 may be provided in between the longitudinal supporting member 20 and the upper longitudinal gutter member 10 for intercoupling these members 10, 20. The main section 412 of bracket 41 is formed to exactly fit at least the outer surfaces of the upper part of the longitudinal supporting member 20 and to exactly fit at least the inner surface of the upper part of the upper longitudinal gutter member 10, such that the main section 412 of the primary bracket 41 of the current embodiment is substantially U-shaped. An outer end section 411 of the bracket may be shaped to enclose, e.g. exactly enclose, at least part of the drainage channel 30 for intercoupling the drainage channel 30 to the longitudinal supporting member 20 and the upper longitudinal gutter member 10 in case said drainage channel 30 is not formed integrally with the upper longitudinal gutter member 10. In the current embodiment, where the drainage channel 30 is formed integrally with the upper longitudinal gutter member 10, the primary bracket 41 also aids the upper longitudinal gutter member 10 and the drainage channel 30 to retain their pre-formed shape. The primary bracket 41 thereby enable to use a thinner formable (plastic) sheet material for forming said upper longitudinal gutter member 10 and drainage channel 30.

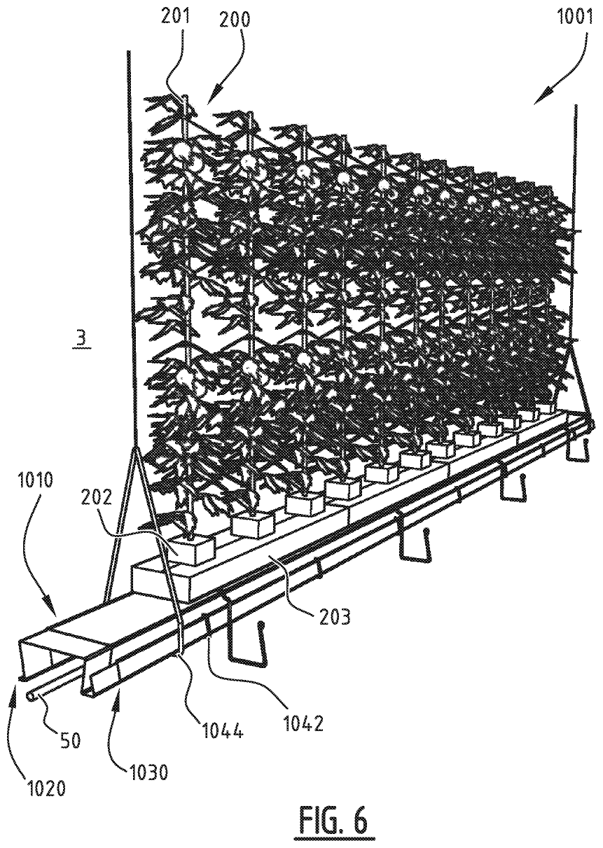

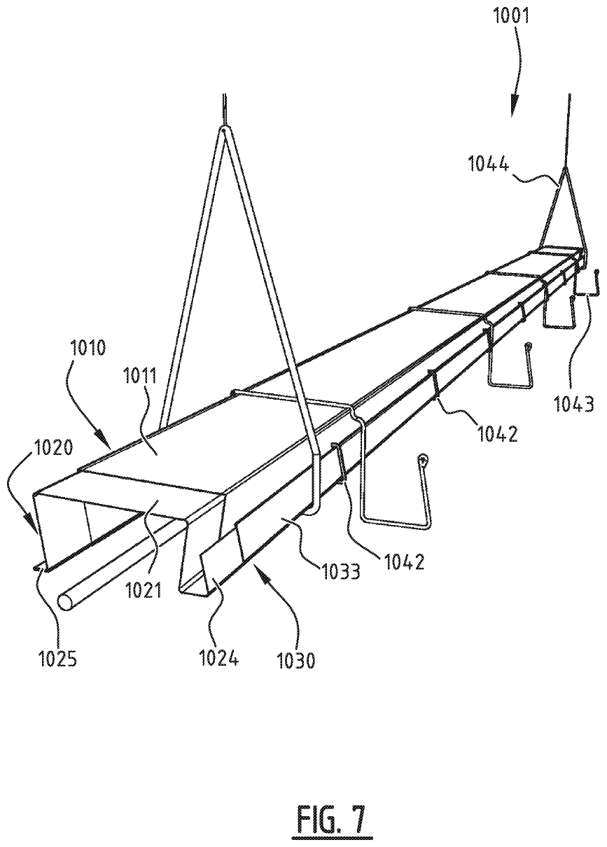

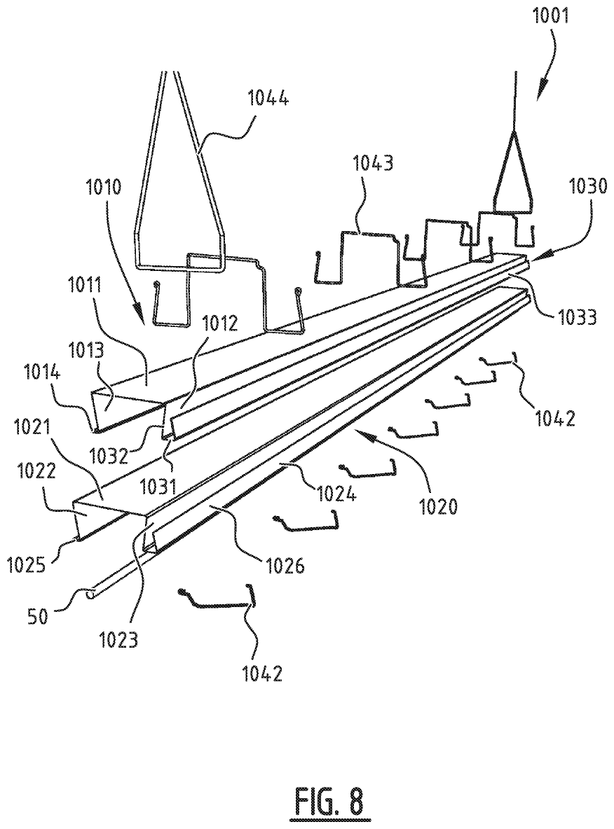

FIGS. 6-8 show a second embodiment of the growing gutter system 1001, which is substantially similar to the first embodiment 1. Differences between the respective embodiments will be discussed. The longitudinal supporting member 1020 provides, like in the first embodiment, for the structural support, and is arranged to comprise a substantial U-shaped cross-section, having a top wall 1021 and respective sidewalls 1022, 1023. The cross-section of the longitudinal supporting member 1010 is thereby open at the lower end. The first leg, i.e. sidewall 1023, of the U-shape is provided with a drainage channel supporting base 1024 that is arranged to provide a structural support for the drainage channel 1030. The opposite sidewall 1022 is arranged, at its outer longitudinal edge, with an outwardly extending edge section 1025 for increasing the stiffness of the longitudinal supporting member 1020.

The upper longitudinal gutter member 1010 is arranged around, i.e. to closely and/or exactly fit, the outer circumference of the longitudinal supporting member 1020. The outer circumference of the longitudinal supporting member 1020 is, like in the first embodiment, thereby shielded from direct contact with drainage water.

The upper longitudinal gutter member 1010 and drainage channel 1030 is again integrally formed, as described above. The side wall 1033 can be arranged to also fold around the corresponding outer side wall 1026 of the drainage channel supporting base 1024, such that the respective outer side wall is substantially fully enclosed by the side wall 1033. Retaining clips 1042 are arranged to enclose the outer side of side wall 1033 at one longitudinal side of the gutter system 1001 and to enclose the longitudinal edge section 1014 of the upper longitudinal gutter member 1010 that is arranged around the extending edge section 1025. The bracket 1042 is seen to extend below the longitudinal supporting member 1020 for this purpose. Secondary brackets 1043 are arranged for to enable to accommodate further tubular members (not shown) to run parallel to the growing gutter system 1, such as flexible perforated foil type tubes used for providing additional CO₂ to the plants 201 for supporting their development, or supporting plant material such as stems.

The growing gutter system 1001 extends through a plurality of suspending brackets 1044 aiding to suspend the growing gutter system to the roof structure of the horticulture greenhouse. The second embodiment thereby functions in substantially the same manner as the first embodiment, whereby it is further noted that the different features of the first and second embodiments may be combined for forming further embodiments. The present invention is not limited to the embodiment shown, but extends also to other embodiments falling within the scope of the appended claims.

1.-25. (canceled)

26. A growing gutter system for supporting horticulture crops placed thereon, comprising:
a longitudinal beam member for supporting the weight of said horticulture crops;
an upper longitudinal gutter member made from a formable plastic sheet material comprising an upper surface for placement of horticulture crops thereon, wherein said upper longitudinal gutter member is made separately from said longitudinal beam member;
a drainage channel running parallel along the length of the upper longitudinal gutter member and wherein the upper longitudinal gutter member is arranged for draining liquid from the upper surface to the drainage channel,
wherein the upper longitudinal gutter member is pre-formed to obtain its shape and is arranged on the longitudinal beam member, such that the pre-formed upper longitudinal gutter member at least partially encloses said longitudinal beam member, such that any liquid draining from said horticulture crops runs over the upper surface towards the drainage channel.

27. The growing gutter system according to claim 26, wherein said upper longitudinal gutter member comprises at least an upper wall that comprises said upper surface and a side wall that extends from the upper wall, with respect to the upper surface thereof, in at least a downward direction and, preferably, wherein an outer surface of said side wall is arranged for guiding the draining liquid from the upper surface to the drainage channel.

28. The growing gutter system according to claim 26, wherein at least a part of an inner circumference of said upper longitudinal gutter member is shaped to closely fit over at least a part of the outer circumference of the longitudinal beam member.

29. The growing gutter system according to claim 26, wherein the drainage channel is formed monolithically with said upper longitudinal gutter member, such that said upper longitudinal gutter member and drainage channel are formed from the same piece of pre-formed material.

30. The growing gutter system according to claim 26, wherein said drainage channel is arranged at, or below, a lower end of the side wall of the longitudinal gutter member.

31. The growing gutter system according to claim 26, wherein the cross-section of the upper longitudinal gutter member is at least L-shaped, and preferably, wherein the leg of the L-shape is arranged with an at least J-shaped end section for forming the drainage channel.

32. The growing gutter system according to claim 26, wherein the sheet material of the upper longitudinal gutter member is a foldable sheet material, in particular a creased and/or scored sheet material, such that the upper longitudinal gutter member is, preferably, pre-formed by folding along pre-applied creasing/scoring lines.

33. The growing gutter system according to claim 26, wherein said sheet material is made from PE (Polyethylene) or PP (Polypropylene).

34. The growing gutter system according to claim 26, wherein the formable sheet material of the upper longitudinal gutter member has a thickness in the range of 0.2-3 mm, preferably in the range of 0.3-1.5 mm, more preferably in the range of 0.4-1 mm, most preferably in the range of 0.4-0.8 mm.

35. The growing gutter system according to claim 26, comprising a second drainage channel running parallel along the length of the upper longitudinal gutter member and wherein the upper longitudinal gutter member is also arranged for draining liquid from the upper surface to the second drainage channel, such that, preferably a cross-section of the growing gutter system is substantially mirror symmetric with respect to a mirror line running substantially perpendicular to the upper surface and through a central longitudinal axis of the growing gutter system.

36. The growing gutter system according to claim 26, wherein, when determined at a nominal temperature of 20° C., said upper longitudinal gutter member is arranged on the longitudinal beam member with a pretension; preferably wherein said longitudinal beam member comprises, at the respective end sections, upper longitudinal gutter member attachment sections arranged for a pre-tensioned fixation of said upper longitudinal gutter member to the longitudinal beam member, preferably wherein said longitudinal beam member is made from metal sheet material, preferably steel sheet material.

37. The growing gutter system according to claim 26, wherein the longitudinal beam member is a thin-walled longitudinal beam member having a cross-section that comprises at least a U-shaped or semi-circular section;
preferably wherein said thin-walled longitudinal beam member comprises a substantially closed cross-section or an open cross-section having a curl, extending edge section, or hem at the longitudinal edges.

38. The growing gutter system according to claim 26, comprising a plurality of joining bracket members, wherein said bracket members are arranged for holding and adjoining said longitudinal beam member, said upper longitudinal gutter member and, preferably, said drainage channel(s).

39. The growing gutter system according to claim 38, wherein said joining bracket members are arranged around the outer circumference of the longitudinal beam member, such that said bracket members are in between the longitudinal beam member and the upper longitudinal gutter member and preferably, wherein said joining bracket members comprise a holding end section for holding the upper longitudinal gutter member in the pre-formed shape, wherein the holding end section preferably comprise one or two J-shaped end sections for holding therein the drainage channel(s) in their pre-formed shape; or
wherein said joining bracket members are arranged around at least a part of the outer circumference of the upper longitudinal gutter member, in particular around outer longitudinal edges of the upper longitudinal gutter member, such that said bracket members are arranged around the longitudinal beam member and the upper longitudinal gutter member; and/or wherein, preferably, the longitudinal beam member is provided with (a) drainage channel supporting base(s) for holding therein the drainage channel(s) in their pre-formed shape.

40. The growing gutter system according to claim 26, wherein said system further comprises a suspension system for suspending said grower gutter system from a suspended structure and/or roof structure of a horticulture green house at a predefined elevation height, said suspension system, preferably, comprising a plurality of longitudinal tension members, such as cables, that are arranged to extend downwardly from the suspended structure and/or roof structure of a horticulture green house and/or a plurality of suspension brackets that coupled to the longitudinal beam member and are arranged for connecting to a plurality of longitudinal tension members extending downwardly from the suspended structure and/or roof structure of a horticulture green house.

41. A method of manufacturing a growing gutter system, comprising the steps of:
providing a longitudinal beam member for supporting the weight of horticulture crops;
providing an upper longitudinal gutter member made from a formable sheet material comprising an upper surface for placement of horticulture crops thereon, wherein said upper longitudinal gutter member is made separately from said longitudinal beam member;
providing a drainage channel;
arranging said upper longitudinal gutter member on the longitudinal beam member, such that the pre-formed upper longitudinal gutter member at least partially encloses said longitudinal beam member; and
arranging said drainage channel such that any liquid draining from said horticulture crops runs over the upper surface towards the drainage channel.

42. The method of manufacturing according to claim 41, wherein the step of providing the upper longitudinal gutter member comprises:
providing a longitudinal sheet of a formable sheet material, preferably having pre-arranged scoring and/or ceasing lines;
forming said upper longitudinal gutter member by bending, preferably along longitudinal creasing and/or scoring lines, said longitudinal sheet of formable sheet material to obtain at least an intermediate shaped gutter member having cross-sectional shape that is in between the undeformed shape of said longitudinal sheet and a final cross-sectional shape of said upper longitudinal gutter member,
and wherein step of arranging said upper longitudinal gutter member on the longitudinal beam member comprises:
obtaining the final cross-sectional shape of the upper longitudinal gutter member and arranging it on the longitudinal beam member.

43. The method of manufacturing according to claim 41, wherein the step providing the upper longitudinal gutter member comprises:
providing the longitudinal sheet of a formable sheet material on a roll;
rolling off the longitudinal sheet of formable material from the roll, while simultaneously bending the rolled off material to obtain the cross-sectional shape of at least intermediate shaped gutter member.

44. The method of manufacturing according to claim 41, wherein the step of providing a longitudinal beam member comprises the steps of:
providing a longitudinal sheet of a secondary formable sheet material, preferably a metal sheet material, preferably on a roll of said secondary formable sheet material;
forming said longitudinal beam member to have a predefined cross-section, with respect to a longitudinal axis of said longitudinal beam member, by bending and plastically deforming said secondary formable sheet material; preferably by rolling off said material from the roll while simultaneously bending and plastically deforming the rolled off secondary material to obtain the longitudinal beam member having the predefined cross-section;
preferably wherein the steps of forming the cross-sectional shape of the upper longitudinal gutter member and the longitudinal beam member are performed simultaneously and in parallel to each other and wherein the cross-sectional shape of the upper longitudinal gutter member is arranged on the cross-sectional shape of the longitudinal beam member after forming the respective cross-sectional shapes.

45. The method of manufacturing according to claim 41, wherein the drainage channel is monolithically formed with the upper longitudinal gutter member, preferably through bending the longitudinal sheet of a formable sheet material; or wherein the method is executed in the horticulture greenhouse wherein the growing gutter system is to be suspended.
